(19) United States
(12) Patent Application Publication
(10) Pub. No.: US 2001/0040948 A1
(43) Pub. Date: Nov. 15, 2001

(54) INTERNET PRIORITY CALL DEVICE

(76) Inventors: WILLIAM C. MCCLURE, AURORA, CO (US); BOB D. KUNCE, JOPLIN, MO (US); CHARLES E. COPELAND, NORTHGLENN, CO (US); Gary S. Smock, Arvada, CO (US)

Correspondence Address: PITTENGER AND SMITH, 717 SEVENTEENTH STREET SUITE 1470, DENVER, CO, 80202

(21) Appl. No.: 09/268,805

(22) Filed: Mar. 16, 1999

Related U.S. Application Data
(63) Continuation-in-part of application No. 09/084,331, filed on May 26, 1998.

(51) Int. Cl. H04M 11/00; H04M 15/06

(52) U.S. Cl. 379/142.15; 379/142.07; 379/93.17

(57) ABSTRACT

A method and apparatus to inform an online computer user of the presence of an incoming telephone call without disturbing an associated modem connection is disclosed. A telephony device is connected to a telephone line, modem and telephone set, and utilizes a Call Waiting service provided by the telephone company. Upon detection of a Call Waiting signal the telephony device generates a four second warbling tone to a piezoelectric sounder alert the user to the presence of an inbound telephone call. The user may answer or ignore the telephone call. Caller identifiers included in incoming calls may be used to alert the user of the origin of the incoming call before the user decides to accept or ignore the call. When the telephony device determines that the user has lifted the telephone set, it places the modem on hold, generates a signal displayed as a colored LED display, connects the telephone to the incoming tip/ring connection, thus establishing a connection to the caller. When the user terminates the call by replacing the telephone set, the telephony device may generate another signal displayed on the LED display, and reconnect the modem to the Internet service provider.

### This application is a continuation in part of U.S. application Ser. No. 09/084,331 filed May 26, 1998, which is co-pending.

### FIELD OF THE INVENTION

The present invention relates broadly to the field of telephony and the use of modems and computers. More specifically, the present invention relates to a method and apparatus for informing a computer modem user of the presence of an inbound telephone call, and allowing the user to place the modem connection on hold, receive the call, and either preserve or sever the modem connection. The present invention also allows a standalone or integrated “Caller ID” apparatus to receive Caller ID data while maintaining the modem connection.

### BACKGROUND OF THE INVENTION

With the proliferation of Internet service providers (ISP), increased modem capacity and the growing popularity of global computer networks, many people spend considerable amounts of time at their computers connected to their respective ISP via a modem. In order to preserve the modem connection, the popular telephone feature of Call Waiting (CW) must be disabled, or data transfer over the modem will be disturbed. However, some modems are able to recover from the interruption of Call Waiting, and may restore any lost data by sending an interrupt signal to the ISP modem. Thus, the Call Waiting signal is unnoticeable to the computer user. As a result, the computer user is unreachable by telephone while connected to the ISP unless a second telephone line is provided. Many existing homes have only one telephone line, and the cost of installing a second telephone line and paying an additional monthly service fee make the second telephone line an undesirable solution.

Another popular telephone feature is Caller ID (CID), where the telephone number and possibly the name of the caller is displayed to a user before the user accepts the incoming call. A device that could utilize the features of Call Waiting and Caller ID to allow a user to identify callers while simultaneously using a computer modem on the same telephone line would prove very convenient and useful.

### PRIOR ART DISCLOSURE STATEMENT

U.S. Pat. No. 4,995,074 to Goldman et al. discloses a system for interrupting a data session between computers connected over a telephone line to allow the handling of an incoming call and restoring the connection between computers once the incoming call is terminated. The Goldman patent teaches a system wherein an interface must be is physically located at both the host computer site and the terminal user site.

The present invention teaches a method and apparatus for interrupting computers connected over a telephone line to allow the handling of an incoming telephone call and restoring the connection between computers after the incoming call is terminated, but is far simpler than the system disclosed in the Goldman patent. In the present invention, there is no need for hardware or software to be physically located at both the host site and terminal site; the present invention teaches a system located only at the terminal site. Thus, the present invention does not limit a user to computers employing a matching interface and allows the user to receive incoming calls while connected to any host computer. Because the present invention does not require the host computer to use any special hardware or software, fewer components are required than in the system disclosed in Goldman, making the present invention less expensive to produce and install.

### SUMMARY OF THE INVENTION

The present invention provides a method and apparatus to inform an online computer user of the presence of an incoming telephone call without disturbing the modem connection. The present invention comprises a telephony device connected to a telephone line, modem and telephone, and utilizes a Call Waiting service provided by the telephone company. The telephony device meets and operates under the telephony standards set forth in Bellcore documents GR-30-CORE, SR-TSV-002476, TR-NWT-000031, TR-NWT-000575, and TR-NWT-001188. The Call Waiting service indicates the presence of an incoming call by providing a Subscriber Alert Signal (SAS) or Call Waiting alert signal, defined as two tone bursts separated by approximately 9.7 seconds of silence, each burst having a duration of approximately 300 ms and a frequency of approximately 440 Hz. Upon detection of an alert tone or signal, the present invention generates a four second warbling tone to a piezoelectric sounding device or energizes a ringer, thus alerting the user to the presence of the inbound telephone call. The user may answer or ignore the telephone call. CID data can also be transmitted to CID subscribers following the Call Waiting alert signal and may be used to alert the user of the origin of the incoming call before the user decides to accept or ignore the call.

CID information is generally displayed to users via a display telephone set, Customer Premises Equipment (CPE) or CID display device, which can be a peripheral telephony device with a liquid crystal display (LCD) which provides the callers name and telephone number to the user. The CID display device is notified that Caller ID data is coming by a Caller ID alert signal which follows the Call Waiting alert signal by approximately 50 ms. The CID alert signal is a dual tone multi-frequency (DTMF) signal (2130 Hz and 2750 Hz) which lasts for approximately 80 ms. Upon receiving the CID alert signal, the display device sends a DTMF (941 Hz and 1633 Hz) acknowledgment signal to the central office which then transmits the CID data to the CID display device. According to Bellcore requirements, this entire transaction should not take longer than 1.2 seconds.

A problem may arise when the modem attempts to renegotiate with the Internet service provider after the Call Waiting alert signal is received as the modem signals may interfere with the CID display alert signal, preventing the display device from being alerted to receive the CID data. The central office automatically mutes the ISP side of the connection for 80 ms to prevent interference with the display alert signal. To ensure that the CID data is received by the display device, the present invention may further provide for both the modem port and the telephone port to be placed on hold and a termination circuit to be activated upon receipt of the Call Waiting alert signal. The termination circuit provides an impedance required per Bellcore specifications to maintain the voltage drop needed to keep the connection open. After a period of 1.25 seconds, to ensure the completion of the CID data transmission to the display device, the termination circuit is deactivated and the modem port and telephone port are reconnected to the telephone line allowing either the modem to renegotiate or the user to answer the call.

When the telephony device determines that the user has lifted the telephone set, it places both the telephone and modem on hold, creates a hook flash signal by waiting 700 ms in the on-hold status, then connects the telephone to the telephone line, thus establishing a connection to the caller. When the user terminates the call by replacing the telephone set, the device will generate another hook flash signal and possibly reconnect the modem to the ISP. If the user picks up and hangs up quickly (within 5-15 seconds depending on baud rate, modem and service provider) the modem may be able to reestablish the previous connection without having to redial the ISP.

In one aspect, the present invention provides a method of interfacing an online computer user, a modem, and incoming telephone calls by detecting the presence of an incoming telephone call, notifying the computer user of the incoming call, placing the modem on hold, connecting the computer user with the incoming telephone call, and restoring the modem connection when the user terminates the incoming telephone call. Caller identification may also be performed, thus providing a filtering mechanism for the user. The user can be alerted to the identification of every incoming call, or only designated callers. The user may be alerted by a light emitting diode (LED), audible signal, or a voice delivered over a speaker.

In another aspect, the present invention provides a telephony device for interfacing an online computer user, modem and incoming telephone calls. The telephony device is attached to a modem, telephone set, and telephone line utilizing the Call Waiting feature. The telephony device includes a connection for a telephone line, a connection for a telephone set, and a connection for a modem. It further includes a switch for switching the telephone set and the modem between the telephone line and a hold bus, a processor for detecting the presence of a Call Waiting alert signal and controllably operating the switch, and a signal generator for alert the user of the presence of an incoming telephone call. The alert signal may be a lighted display, an audible sound or ringer, or a synthesized voice.

The device may also incorporate a CID display to alert the user of the origin of every incoming call, or only alert the user to incoming calls from designated callers. Certain telephone numbers may be programmed into the device so that special treatment and priority can be given to those designated callers. A prerecorded message may also be activated by the user to impart a message of the user's choosing to a caller, such as informing the caller that the user is operating a computer modem on the telephone line and requesting the caller to call back later. The device may further incorporate a telephone set, a modem, or both for optimal convenience to the user in optional embodiments. Additionally, the device may provide a calling party control (CPC) feature to sense when a telephone set on an upstream extension is taken off-hook. The user, at his discretion, could set the calling party control feature to either direct the modem port to hang up and allow an extension call to be placed, or ignore the extension pick up and maintain the connection with the Internet service provider.

Other features and advantages of the present invention will become apparent from the following detailed description of the invention when it is considered in conjunction with the accompanying drawings.

### BRIEF DESCRIPTION OF THE DRAWINGS

FIG. 1 is a block diagram illustrating the major components of the present invention;

FIG. 2 is a block diagram illustrating an alternate embodiment of the present invention for accessing caller identification information;

FIG. 3 is a logic diagram showing the sequence of operation of the various states of the present invention;

FIG. 4 is a logic diagram showing an alternate embodiment of the various states of the present invention; and

FIG. 5 is a logic diagram showing the sequence of steps executed by the caller identification state of the present invention.

### DETAILED DESCRIPTION OF THE DRAWINGS

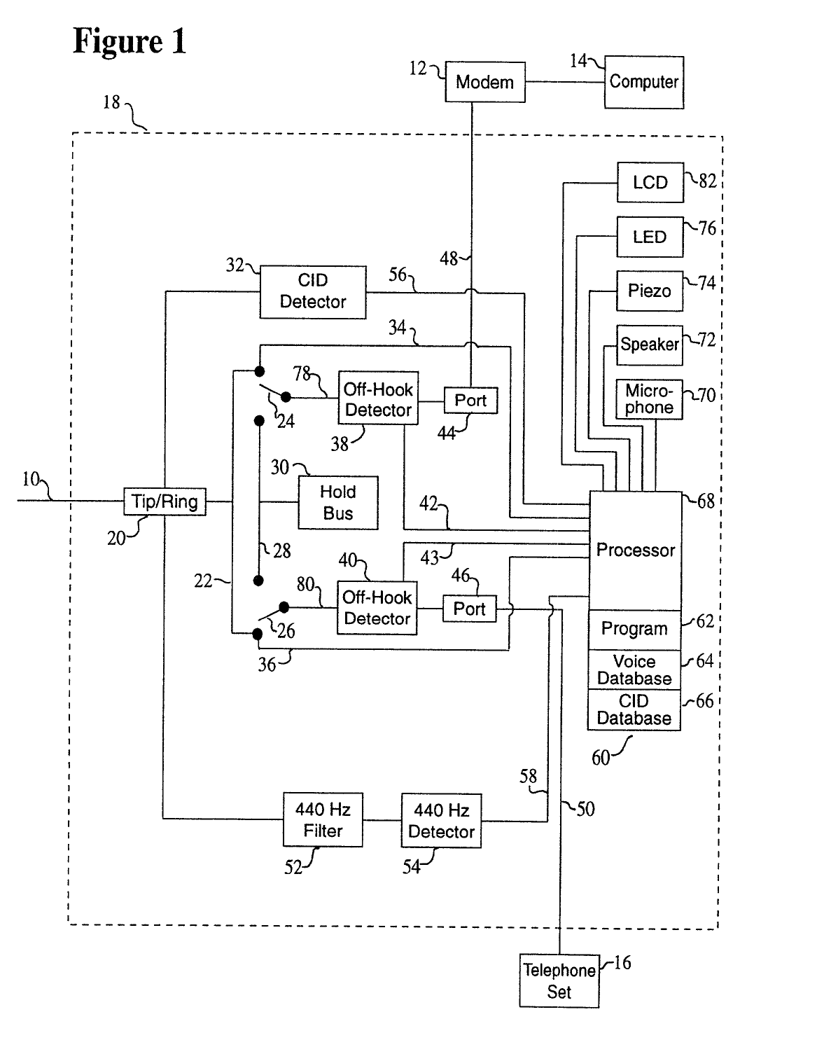

Directing attention to FIG. 1, the major components of the present invention are illustrated in block diagram form. An incoming telephone line 10 is connected to telephony device 18. Telephony device 18 is a telephone switching device that switches the telephone line between a telephone set 16 and a modem 12. The telephone line 10 connects directly to the tip/ring connection 20. The modem 12 is connected to the telephony device 18 via modem port 44 and modem port line 48, thus enabling computer 14 to communicate over the telephone line 10 with remotely located computers. Likewise, the telephone set 16 is connected to the telephony device 18 via telephone port 46 and line 50. Switching between the telephone set 16 and modem 12 is performed by processor 68, which controls the modem relay 24 and telephone relay 26 by modem relay lead 34 and telephone relay lead 36, respectively. Between the modem relay 24 and the modem port 44 is the modem off-hook (OH) detector 38. The modem OH detector 38 monitors the modem tip/ring line 78 to detect a current draw, which indicates that the modem 12 is in use. Modem OH detector lead 42 indicates the current draw to the processor 68. Similarly, the telephone OH detector 40, located between the telephone relay 26 and telephone port 46, performs the same function for the telephone set 16, monitoring telephone tip/ring line 80 and indicating the current draw to processor 68 over line 43. The modem relay 24 and telephone relay 26 can switch between the tip/ring connection 20 and a hold bus 30. The hold bus 30 maintains +40 vdc and can place either the telephone set 16, the modem 12, or both on hold via hold bus line 28.

A 440 Hz filter 52 and 440 Hz detector 54 are also connected to the tip/ring connection 20. These two components monitor the telephone line 10 for the presence of a Call Waiting signal. The 440 Hz detector 54 alerts the processor 68 of the presence of the Call Waiting signal over line 58. A Caller ID detector 32 may also be included in the telephony device 18, and is connected to the tip/ring connection 20 to monitor the telephone line 10 for CID signals that may accompany incoming telephone calls. The CID detector 32 communicates the CID signal to the processor 68 over line 56.

Piezoelectric sounder 74 and LED 76 are included in the telephony device 18 to provide an indication to the user of various states of operation of the telephony device 18. The LED 76 is capable of emitting different colors, and may emit a blinking or steady light. Piezoelectric sounder 74 emits an audible “beep” to signal the user. Both the piezoelectric sounder 74 and LED 76 are controlled by the processor 68. If desired, a simple ringer on the telephone port 46 may be substituted for the piezoelectric sounder 74.

The processor 68 incorporates memory 60, which contains program 62 that operates telephony device 18. In the preferred embodiment of the present invention, an Intel 8051 microprocessor is used as the processor 68, but other similar and suitable microprocessors may be used. Memory 60 may also contain CID database 66, which contains CID numbers entered or preprogrammed by the user. The caller identification numbers stored in the CID database 66 may be used to filter incoming calls and only allow calls that have CID numbers stored in the CID database to be indicated to the user or to indicate a priority call.

Memory 60 may also contain voice database 64, which contains synthesized voice messages which indicate the various states of operation of the telephony device 18, as well as announce the name and telephone number of the caller to the user. The voice messages stored in the voice database 64 are played to the user over the speaker 72.

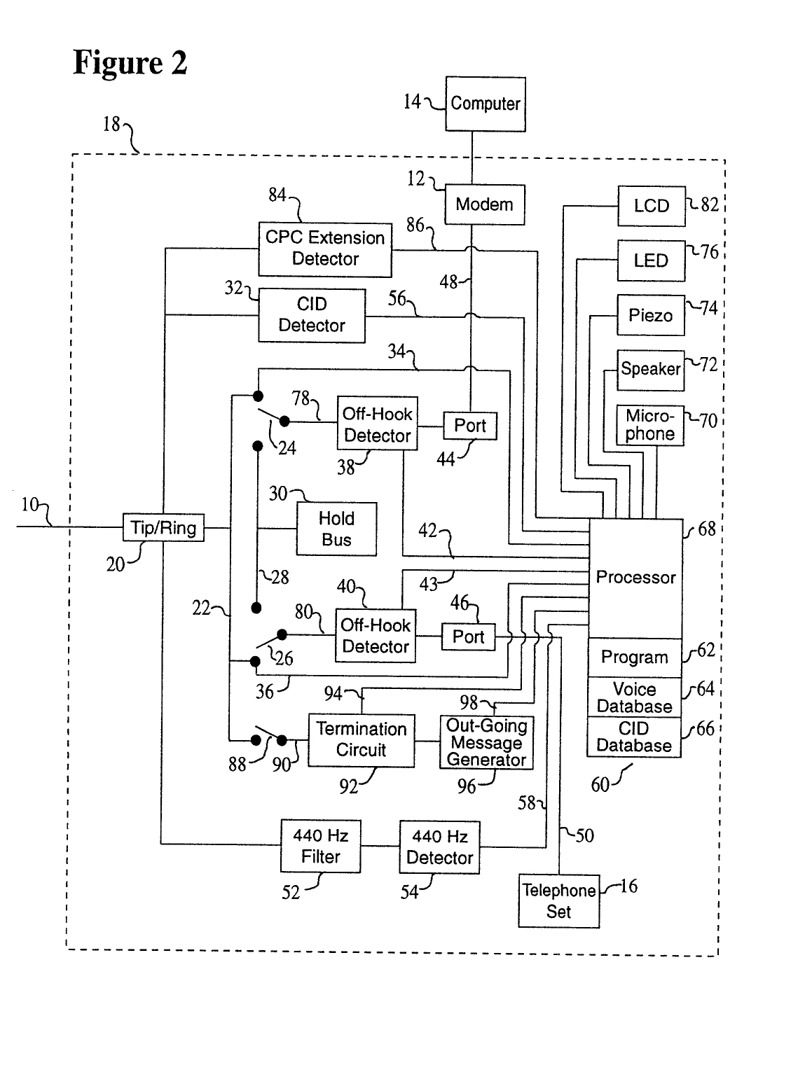

An alternate embodiment of the present invention, as shown in FIG. 2, provides an optional configuration for retrieving CID information. The telephony device 18 is substantially the same as in FIG. 1, but additionally incorporates termination relay 88 and termination circuit 92. In this embodiment, when the processor 68 receives notification of a Call Waiting alert signal from the 440 Hz detector 54, the program 62 instructs the processor 68 to close the termination relay 88 via termination relay line 94. This connects the termination circuit 92 to the tip/ring line 22 via the line 90.

FIG. 2 also depicts an out-going message generator 96 activated by processor 68 via out-going message line 98. The out-going message generator 96 may be activated by the user to communicate a stored message in the voice database 64 to callers. The out-going message generator 96 is connected through the termination circuit 92 to the tip/ring line 22, and is thereby played when the termination circuit is actuated.

The embodiment in FIG. 2 further incorporates a calling party control detector 84 which monitors the tip/ring connection 22 for upstream extension pick ups. If a telephone set elsewhere on the user end is taken off-hook, the processor 68 is informed by the calling party control detector 84 through the line 86. The user may direct the telephony device 18 to ignore the extension pick up or alternately sever the modem 12 connection to the ISP and allow the upstream telephone call to be made. This selection may be preprogrammed by the user and stored in memory 60, or the user may decide whether to take the modem 12 off-line in real time.

FIG. 2 additionally shows how the modem 12 and telephone set 16 may optionally be incorporated into the telephony device 18 that makes up the present invention. These options may allow a user to select an integrated telephony device 18 optimally suited to his needs.

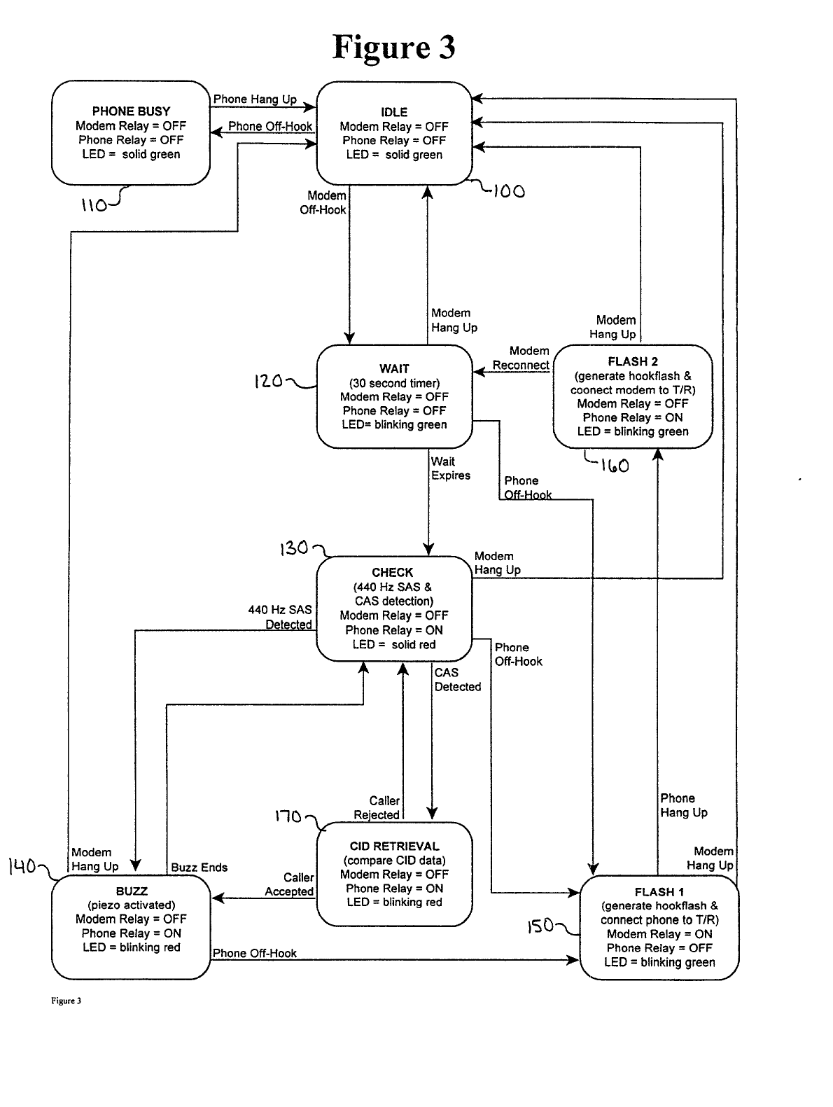

FIG. 3 depicts the various operational states of the telephony device 18: idle state 100, phone busy state 110, wait state 120, check state 130, buzz state 140, flash1 state 150, flash2 state 160, and Caller ID (CID) retrieval state 170. When the telephony device 18 is in the idle state 100, the telephone relay 26 and modem relay 24 are connected to the tip/ring connection 20 and the LED 76 displays a solid green light. If the modem port 44 picks up, the telephony device 18 enters the wait state 120. If the telephone port 46 picks up, the telephony device 18 enters the phone busy state 110. No action is taken when the telephony device 18 is in the phone busy state 110. The telephony device 18 waits in the phone busy state 110 until the telephone set 16 is placed on-hook while maintaining a solid green LED 76.

Upon entering the wait state 120, the telephone port 46 is immediately placed on the hold bus 30 and a thirty-second count down is executed by the processor 68. During this thirty-second interval the LED 76 flashes green indicating that the modem 12 is off-hook, but the telephony device 18 is not monitoring the telephone line 10 to detect a Call Waiting alert signal. This wait interval is required to avoid misinterpreting dial tone and initial modem negotiations as a Call Waiting signal. If the modem 12 hangs up, the telephony device 18 returns to the idle state 100. If the telephone set 16 is taken off-hook, the telephony device 18 enters the flash1 state 150. Upon completion of the thirty-second countdown, the telephony device 18 enters the check state 130.

When the telephony device 18 enters the check state 130, the LED 76 is immediately changed to solid red to indicate that the telephony device 18 is monitoring telephone line 10 for a Call Waiting signal. If the alert signal is detected by the 440 Hz detector 54, the telephony device 18 enters the buzz state 140. If a Caller ID signal is detected, the CID retrieval state 170 is entered. In the CID retrieval state 170, the user may ascertain the identity of the caller and decide whether to accept or reject the call. If the user rejects the call, control returns to the check state 130. If the user accepts the call, control is transferred to the buzz state 140. Returning to the check state 130, if a Call Waiting alert signal is detected without a following CID signal, control is transferred directly to the buzz state 140. While in the buzz state 140, if the modem 12 hangs up, the telephony device 18 enters the idle state 100. If the telephone set 16 goes off-hook, the telephony device 18 enters the flash1 state 150.

When the telephony device 18 enters the buzz state 140, the LED 76 flashes red at rapid intervals, while the piezoelectric sounder 74 or a ringer is activated for a duration of approximately four seconds. The telephony device 18 then waits an additional four seconds silently while ignoring the 440 Hz detector 54. This delay insures modem renegotiation (caused by the Call Waiting alert signal) is not falsely interpreted as a second Call Waiting signal tone. At the end of eight seconds the check state 130 is activated. The telephony device 18 enters the flash1 state 150 if the telephone set 16 goes off-hook during the eight-second interval. The telephony device 18 enters the idle state 100 if the modem port 44 hangs up during the eight-second interval.

When the telephony device 18 enters the flash1 state 150, the modem port 44 and the telephone port 46 are put on the hold bus 30 for 700 ms to generate a hook flash signal. The LED 76 turns to flashing green, indicating Call Waiting signal detection is disarmed. The LED 76 continues to blink green while modem 12 is off-hook. If the modem 12 hangs up, idle state 100 is entered and the LED 76 changes to solid green. At the end of this interval the telephone port 46 is put on tip/ring connection 20 and the telephone set 16 is connected to the calling party. The microphone 70 and speaker 72 may be activated at this time, enabling the telephony device 18 to provide a hands free speaker telephone. The telephony device 18 waits in the flash1 state 150 indefinitely until the telephone set 16 hangs up. If the telephone port 46 goes on-hook, the telephony device 18 enters the flash2 state 160.

When the telephony device 18 enters the flash2 state 160, the modem port 44 and the telephone port 46 are put on the hold bus 30 for 700 ms to generate a hook flash signal. The LED 76 continues to indicate the modem on-hold status by flashing green. If the modem port 44 hangs up during this period, control is returned to the idle state 100 and the modem port 44 is put on the tip/ring connection 20 and the modem 12 is reconnected to the telephone line 10. If the modem 12 is reconnected within an acceptable time period, usually five to fifteen seconds, the modem connection is reestablished without the need to redial. Upon generation of the hook flash signal, the wait state 120 is activated.

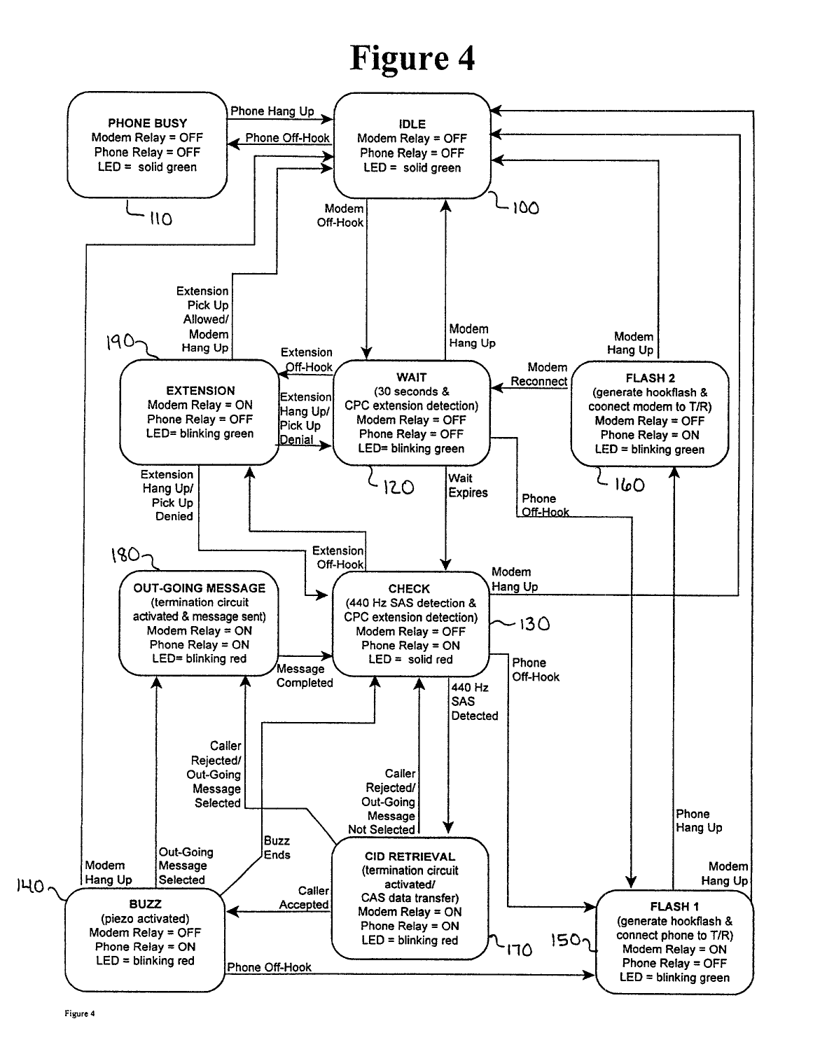

FIG. 4 depicts an alternative method of implementing CID retrieval state 170. Rather than monitoring for both a Call Waiting signal and a Caller ID signal in the check state 130, this method relies solely on the 440 Hz Call Waiting tone. When the Call Waiting signal is detected by the 440 Hz detector 54, the processor 68 switches the termination relay 88 and applies the termination circuit 92 to the tip/ring line 22. After 5 ms the modem relay 24 is switched to the hold bus 30 placing the modem 12 on hold. The modem 12 remains on hold for 1.25 seconds while in the CID retrieval state 170 to allow the CID detector 32 to receive and acknowledge the CAS tone, collect the CID data, and transfer the data to the processor. Applying the termination circuit 92 and placing the modem 12 on hold prevents the possibility of modem communication interference with the CID alert signal reception, acknowledgment, and data transmission signals. After the 1.25 second hold period, the modem relay 24 is switched back to the tip/ring line 22 placing the modem 12 back on line. The termination circuit 92 is removed from the line approximately 5 ms later.

The present invention may additionally operate in conjunction with third party CID devices. Incorporation of the CID detector 32 into the present telephony device 18 would be unnecessary. The function of the termination circuit 92 may allow such third party CID devices, linked in series with and prior to telephony device 18 on telephone line 10, to receive the CID alert signal and CID data for display without possibility of interference from modem 12 communications.

If the call is accepted in CID retrieval state 170, the telephony device 18 enters the buzz state 140 and the piezoelectric sounder74 is actuated to alert the user. An additional out-going message state 180 is identified in FIG. 4 which may communicate a message to the caller if the user decides not to answer the incoming call. The out-going message state may be entered through either the buzz state 140 or the CID retrieval state 170. If the user selects the option of providing an out-going message, for calls that are either screened out in the CID retrieval state 170 or are not answered after the buzz state 140 notifies the user, the out-going message state 180 is entered. If the user does not select the out-going message option, control simply returns to the check state 130.

To provide an out-going message, the termination circuit 92 is actuated and after approximately 5 ms the modem relay 24 is switched to the hold bus 30 and modem 12 is placed on hold. The processor 68 then actuates the out-going message generator 96 which provides the caller with a message previously stored by the user in the voice database 64 in memory 60. During the message communication, the LED 76 blinks red to indicate the check state 130 functions are being temporarily interrupted. Upon completion of the message, the modem 12 is reconnected to the tip/ring line 22 and approximately 5 ms later the termination circuit is removed.

FIG. 4 also discloses an additional function which may be undertaken in the check state 130. There maybe an occasion where an upstream telephone set at the user's location is taken off-hook in an attempt to place a call. Extension state 190 may provide the user with the option to allow or deny such upstream line use to proceed. While in either the wait state 120 or the check state 130, the telephony device 18 may simultaneously monitor for upstream extension pick up pursuant to CID display device guidelines. If an extension is taken off-hook, the telephony device 18 enters the extension state 190. While in the extension state 190, the LED 76 blinks green to indicate the extension pickup and that Call Waiting detection is arrested. If the user has chosen to deny extension use or the extension is returned to an on-hook position within 5-10 seconds, the telephony device returns to the state from which it came, either the wait state 120 or the check state 130. If the extension remains off-hook for over 5-10 seconds, the modem 12 is taken off line and placed on the hold bus 30 to allow the upstream call to be placed. The user may be notified that the modem connection is being severed in favor of the upstream extension by activation of the piezoelectric sounder 74 in a pattern distinct from the buzz state 140.

While the above explanation of operational states describes different uses of the piezoelectric sounder 74 and LED 76, each operational state may also be indicated to the user by an appropriate voice message retrieved from the voice database 64 and played over the speaker 72.

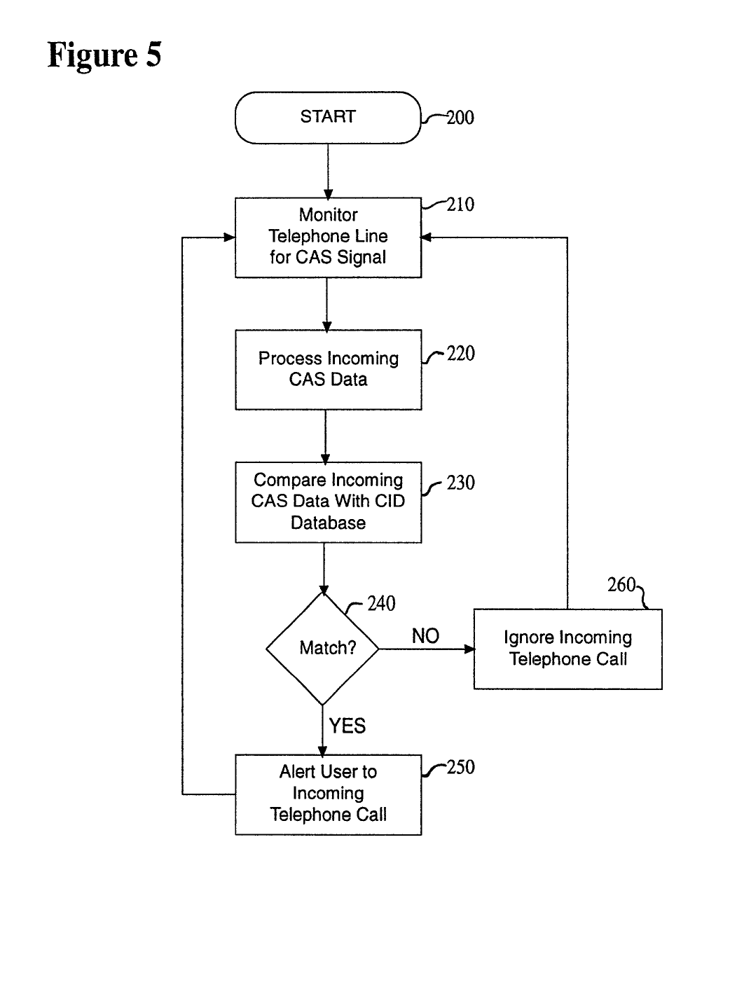

FIG. 5 shows the logical sequence of steps executed by the program 62 to handle CID information. This sequence may operate in combination with step 170 of either FIG. 3 or FIG. 4 as described above. At step 200, the telephony device 18 is powered up, and the CID detector 32 begins monitoring the tip/ring connection 20 for the presence of a Caller ID alert signal (step 210). The alert signal may be the type supplied by telephone companies. When an incoming call contains CID data, the CID detector 32 directs the CID data to the processor 68 (step 220). At step 230, the processor 68 compares the CID information with the CID database 66, which contains telephone numbers entered or programmed by the user. If there is a match between the incoming CID information and a telephone number in the CID database 66, the user is alerted at step 250. If there is no match, the incoming call may be ignored and the user is not alerted (step 260). In this manner, the user may use the telephony device 18 to filter or screen incoming calls. The user may be alerted by the speaker 72, which will announce numbers or prerecorded names contained in the voice database 64. Alternatively, the piezoelectric sounder 74 may be activated to indicate the presence of the incoming call which contains a matching telephone number. An LCD display 82 showing the caller's identification may also be used.

While an improved method and apparatus for alert a user of the presence of an incoming telephone call received while the user is connected to a remote computer via a modem has been described and illustrated in detail, it is to be understood that changes and modifications to the present invention may be achieved without departing from the spirit of the present invention.

1. A method of interfacing an online computer user, a telephone set, a modem connected to said computer, an incoming telephone call, a telephone line connected to said modem utilizing the features of call waiting and its signal, and caller id and its signal and caller id data, said method comprising the steps of:
a) controllably switching said modem and said telephone set to said telephone line;
b) connecting the computer user with an incoming telephone call while said modem is connected to said telephone line; and
c) said step of connecting with an incoming telephone call further including the steps of:
1) detecting the presence of a received Call Waiting signal, said signal being indicative of an incoming telephone call;
2) notifying the computer user of said incoming telephone call;
3) switching said modem from said telephone line to said hold bus; and
4) switching said telephone set to said telephone line so that the computer user can receive the incoming telephone call.

2. A method of interfacing as described in claim 1, further comprising the steps of receiving caller identification information data from said incoming telephone call and displaying said caller identification information data to said computer user.

3. A method of interfacing as described in claim 2, wherein said step of receiving further comprises the steps of:
a) applying a termination voltage to said telephone line upon detection of said Call Waiting signal;
b) switching said modem and said telephone set to said hold bus;
c) allowing a caller identification device to communicate with and receive data from a central telephone office over said telephone line;
d) switching said modem and said telephone set from said hold bus to said telephone line; and
e) removing said termination voltage from said telephone line.

4. A method of interfacing as described in claim 2, further comprising the steps of:
a) filtering said incoming telephone calls by comparing preprogrammed caller identification data to said received caller identification data; and
b) restricting said notification of said computer user to only said incoming telephone calls which match said predetermined caller identification data.

5. A method of interfacing as described in claim 1, further comprising the step of restoring said modem connection to said telephone line when the computer user terminates said incoming telephone call.

6. A method of interfacing as described in claim 5, wherein the step of restoring further comprises the steps of:
a) detecting when said telephone set is placed on-hook;
b) waiting the duration of one hook flash signal; and
c) switching said modem from said hold bus to said telephone line.

7. A method of interfacing as described in claim 1, wherein said step of switching said modem is limited to when said telephone set is taken off-hook, signifying the computer user's acceptance of said incoming telephone call.

8. A method of interfacing as described in claim 7, further comprising the step of providing an out-going message to said incoming call if said telephone set remains on-hook.

9. A method of interfacing as described in claim 8, wherein said step of providing an out-going message further comprises the steps of:
a) applying a termination voltage to said telephone line;
b) switching said modem and said telephone set to said hold bus;
c) communicating said out-going message to said incoming call over said telephone line;
d) switching said modem and said telephone set from said hold bus to said telephone line; and
e) removing said termination voltage from said telephone line.

10. A method of interfacing as described in claim 1, wherein said step of notifying comprises emitting a light signal to indicate the presence of an incoming telephone call.

11. A method of interfacing as described in claim 1, wherein said step of notifying comprises emitting an aural signal to indicate the presence of an incoming telephone call.

12. A method of interfacing as described in claim 11, wherein said aural signal comprises a voice message.

13. A method of interfacing as described in claim 1, further comprising the step of indicating individual states of operation of said telephony device.

14. A method of interfacing as described claim 13, wherein said step of indicating comprises emitting a signal indicative of an idle state of operation.

15. A method of interfacing as described claim 13, wherein said step of indicating the state of operation comprises emitting a signal indicative of said step of detecting.

16. A method of interfacing as described claim 13, wherein said step of indicating the state of operation comprises emitting a signal indicative of said step of connecting to said incoming telephone call.

17. A method of interfacing as described claim 13, wherein said step of indicating the state of operation comprises emitting a signal indicative of performing said step of notifying.

18. A telephony device for interfacing an online computer user, a modem, and an incoming telephone call, said telephony device being attached to said modem, a telephone set, and a telephone line utilizing the feature of Call Waiting and Caller ID, said telephony device comprising:
a) a switching means for connecting said telephone set and said modem to said telephone line;
b) a signal means for alert the user to the presence of said incoming telephone call;
c) a processing means for detecting the presence of a Call Waiting signal and controllably operating said switching means and said signal means;
d) a memory means for storing programming information for directing the functions of the processing means; and
e) an off-hook detection means for detecting when either said telephone set or said modem is in use.

19. The telephony device as defined in claim 18, further comprising a holding means for placing said telephone set and said modem on hold and a termination means for applying a termination voltage to said telephone line while said modem and said telephone set are on hold.

20. The telephony device as defined in claims 18, wherein said processing means includes means for receiving caller identification information from said incoming telephone call.

21. The telephony device as defined in claim 20, wherein said means for receiving caller identification information further includes means for screening said incoming telephone call by alert the user to said incoming telephone call that matches preprogrammed caller identifications and ignoring said incoming telephone call that does not match said preprogrammed caller identifications.

22. The telephony device as defined in claim 18, wherein said signal means comprises a display means for emitting signals indicative of one or more states of operation of said telephony device.

23. The telephony device as defined in claim 22, wherein said display means further comprises means for emitting a signal indicative of a state of operation wherein said telephony device is idle.

24. The telephony device as defined in claim 22, wherein said display means further comprises means for emitting a signal indicative of a state of operation wherein said telephony device is detecting the presence of a Call Waiting signal.

25. The telephony device as defined in claim 22, wherein said display means further comprises means for emitting a signal indicative of a state of operation wherein said telephony device is switching said telephone line.

26. The telephony device as defined in claim 22, wherein said display means further comprises means for emitting a signal indicative of a state of operation wherein said telephony device is alert the user.

27. The telephony device as defined in claim 18, wherein said signal means comprises an aural signal means.

28. The telephony device as defined in claim 27, wherein said aural signal means includes a voice synthesizer means.

29. The telephony device as defined in claim 18, further comprising a speaker and a microphone which may be used to provide a hands free speaker telephone means.

30. The telephony device as defined in claim 18, wherein said telephone set is incorporated into said telephony device.

31. The telephony device as defined in claim 18, wherein said modem is incorporated into said telephony device.

32. The telephony device as defined in claim 18, further comprising an extension detection means for detecting when an upstream extension is taken off-hook.

33. The telephony device as defined in claim 18, further comprising an out-going message generation means.

34. The telephony device as defined in claim 18, wherein said memory means includes voice message data.

35. The telephony device as defined in claim 18, wherein said memory means includes predetermined caller identification data.

36. A telephony device for interfacing an online computer user, a modem, and an incoming telephone call, said telephony device attached to said modem, a telephone set, and a telephone line utilizing the feature of Call Waiting and Caller ID, said telephony device comprising:
a) a holding means for placing said telephone set and said modem on hold;
b) a switching means for connecting said telephone set and said modem to said telephone line and said holding means;
c) a signal means for alert the user to the presence of said incoming telephone call;
d) a processing means for detecting the presence of a Call Waiting signal and controllably operating said switching means and said signal means;
e) a memory means for storing programming information for directing the functions of the processing means;
f) an off-hook detection means for detecting when either said telephone set or said modem is in use;
g) means for receiving caller identification information from said incoming call; and
h) connections for said telephone line, said modem, and said telephone set.

37. A method of interfacing a computer user, a telephone, a modem, an incoming telephone call, and a telephone line utilizing the feature of Call Waiting and Caller ID, said method comprising the steps of:
a) detecting the presence of a Call Waiting signal and a Caller ID signal, said signals indicating the presence of an incoming telephone call; and
b) indicating the detection of said Call Waiting signal and said Caller ID signal to the computer user.

38. A method of interfacing a computer user, a telephone set, a modem, an incoming telephone call, and a telephone line, said method comprising the steps of:
a) controllably switching said modem and said telephone set between said telephone line and a hold bus; and
b) connecting the user to said telephone line via said telephone set while said modem is connected to said telephone line, said step of connecting to said telephone line further comprising the steps of:
1) detecting when said telephone set is taken off-hook;
2) switching said modem and said telephone set from said telephone line to said hold bus;
3) holding said modem and said telephone set on said hold bus for the duration of one hook flash signal; and
4) switching said telephone set to said telephone line.

39. A method of interfacing as described in claim 38, further comprising the steps of:
a) detecting when said telephone set is placed on-book;
b) waiting the duration of one hook flash signal; and
c) switching said modem from said hold bus to said telephone line.

40. A method of connecting automatically a telephone set to an incoming telephone call while a modem is communicating over a telephone line, said method comprising the steps of:
a) detecting when said telephone set is taken off-hook;
b) removing said modem from said telephone line;
c) holding said telephone set and said modem off said telephone line for the duration of one hook flash signal; and
d) connecting said telephone set to said telephone line.

41. A method of connecting automatically as described in claim 40, further comprising the steps of:
a) detecting when said telephone set is placed on-hook;
b) waiting the duration of one hook flash signal; and
c) reconnecting said modem to said telephone line.

42. A method of interfacing a modem, an upstream extension, and a telephone line, aid method comprising the steps of:
a) controllably switching said modem between said telephone line and a hold bus; and
b) connecting said upstream extension to said telephone line while said modem is connected to said telephone line, said step of connecting further comprising the steps of:
1) detecting when said upstream extension is taken off-hook;
2) switching said modem from said telephone line to said hold bus; and
3) holding said modem on said hold bus, thereby allowing said upstream extension to place a call on said telephone line.

43. A method of interfacing as described in claim 42, further comprising the steps of:
a) detecting when said upstream extension is placed on-hook;
b) waiting the duration of one hook flash signal; and
c) switching said modem from said hold bus to said telephone line.
